(19) United States
(12) Patent Application Publication
(10) Pub. No.: US 2025/0204743 A1
(43) Pub. Date: Jun. 26, 2025

(54) MOP WASHING APPARATUS AND MOP WASHING SYSTEM COMPRISING SAME

(71) Applicant: SAMSUNG ELECTRONICS CO., LTD., Suwon-si (KR)

(72) Inventors: Youngjun CHO, Suwon-si (KR); Hyunju LEE, Suwon-si (KR); Seungryong CHA, Suwon-si (KR); Ingyu CHOI, Suwon-si (KR); Junggyun HAN, Suwon-si (KR)

(73) Assignee: SAMSUNG ELECTRONICS CO., LTD., Suwon-si (KR)

(21) Appl. No.: 19/077,511

(22) Filed: Mar. 12, 2025

Related U.S. Application Data
(63) Continuation of application No. PCT/KR2023/012380, filed on Aug. 22, 2023.

(30) Foreign Application Priority Data
Oct. 18, 2022 (KR) 10-2022-0134484

(51) Int. Cl. A47L 13/50; B01D 35/28; B08B 3/14

(52) U.S. Cl. CPC A47L 13/50; B01D 35/28; B08B 3/14

(57) ABSTRACT

This mop washing system comprises a mop cleaner and a mop washing apparatus. The mop washing apparatus comprises a main body, and a water tank. The mop washing apparatus is a washing tray provided to accommodate a mop to be washed, and comprises a first bottom to allow the water to flow in and includes a guide wall, the guide wall has an opening. The washing tray comprises a second bottom at a lower than the first bottom to accommodate the water discharged through the opening and which includes a washing tray discharge port to allow the water to be discharged the outside of the washing tray. The mop washing apparatus further comprises a drainage tray to at least partially accommodate the washing tray, and comprises a receiving groove so that the drainage tray is at least partially accommodated therein and is detachable.

### CROSS-REFERENCE TO RELATED APPLICATION

This application is a continuation application is a continuation application, under 35 U.S.C. § 111(a), of international application No. PCT/KR2023/012380, filed Aug. 22, 2023, which claims priority under 35 U. S. C. § 119 to Korean Patent Application No. 10-2022-0134484, filed Oct. 18, 2022, the disclosures of which are incorporated herein by reference in their entireties.

### TECHNICAL FIELD

The disclosure relates to a mop washing apparatus, and more particularly to a mop washing apparatus for washing mops of a mop cleaner, and a mop washing system including the same.

### BACKGROUND ART

In general, a mop cleaner is used by attaching a mop to the bottom of the main body of the cleaner.

Recently, various cleaning tools have been developed in the form of rotary mop cleaners with a focus on ease of use. In particular, rotary mop cleaners, in which a mop is configured to be rotated by a motor on the bottom surface of the main body by a motor, have recently been developed.

Such rotary mop cleaners typically include a main body housing, an operation support coupled to the main body housing for movement and operation of the main body housing, and a rotary plate rotatably coupled to the bottom surface of the main body housing, and the like, and are configured to attach and detach a mop or the like to the bottom surface of the rotary plate.

In this case, the bottom surface of the rotary plate is generally formed with a Velcro for attaching a mop, and the mop is formed in a disc shape with one side made of a fabric material suitable for cleaning and the other side having a corresponding Velcro for attaching to the Velcro of the rotary plate.

Such a detachable mop cleaner has the disadvantage that when the mop becomes dirty, the mop may need to be replaced and used, or to be washed and used again.

### DISCLOSURE

### Technical Problem

An embodiment of the present disclosure provides a mop washing apparatus that may be more easily maintained and kept clean, and a mop washing system comprising the same.

An embodiment of the present disclosure provides a mop washing apparatus that may be more easily maintained, and a mop washing system comprising the same.

An embodiment of the present disclosure provides a mop washing apparatus that may automatically wash and spin-dry a mop of a mop cleaner, and a mop washing system comprising the same.

An embodiment of the present disclosure provides a mop washing apparatus that may save water by ensuring that an appropriate amount of water is used, and a mop washing system comprising the same.

Technical tasks to be achieved in this document are not limited to the technical tasks mentioned above, and other technical tasks not mentioned will be clearly understood by those skilled in the art from the description below.

### Technical Solution

According to an embodiment of the present disclosure, a mop washing apparatus may include a main body and a water tank coupleable to and decouplable from the main body. The mop washing apparatus includes a wash tray configured to receive a mop to be washed and receive water supplied from the water tank. The wash tray may include a first bottom including a guide wall configured to guide a flow of the water supplied from the water tank, the guide wall having an opening, and a second bottom arranged at a lower level than the first bottom to receive the water guided through the opening of the guide wall of the first bottom, and the second bottom including a wash tray outlet configured to discharge the water to an outside of the wash tray. The mop washing apparatus includes a drain tray configured to be coupleable to and decouplable from the wash tray and receive at least a portion of the wash tray while the drain tray is coupled to the wash tray. The mop washing apparatus includes a receiving groove arranged in the main body while the receiving groove is coupled to the drain tray and configured to receive at least a portion of the drain tray while the receiving groove is coupled to the drain tray.

The wash tray outlet may include a first wash tray outlet and a second wash tray outlet. The guide wall may be arranged on an edge of the first bottom such that the water flowing into the first bottom may flow dividedly to the first wash tray outlet and the second wash tray outlet.

The main body may further include a release groove arranged in the receiving groove to allow the wash tray and the drain tray to be separated from the receiving groove.

The drain tray may be configured to receive the water discharged from the wash tray outlet. The drain tray may include a drain tray outlet configured to discharge the received water to an outside of the drain tray.

The drain tray outlet may be arranged such that the wash tray is coupled to the drain tray and covered by the wash tray.

The receiving groove may be configured to receive the water discharged from the drain tray. The receiving groove may include a receiving groove outlet configured to discharge the water to an outside of the receiving groove.

The receiving groove outlet may include a strainer.

The wash tray may further include an inlet in which the water flows. The main body may further include a water supply pipe configured to communicate the water tank with the inlet.

The main body may further include a drain tank coupleable to and decouplable from the main body. The main body may further include a drain pipe configured to communicate the receiving groove outlet with the drain tank.

The main body may further include a lever arranged to be coupled to a portion of the wash tray and a portion of the drain tray and configured to seat the wash tray and the drain tray within the receiving groove.

The lever may be arranged to be rotatable within the main body and to allow the wash tray and the drain tray to be separated from the receiving groove.

The wash tray outlet and the drain tray outlet each may include a strainer.

The wash tray may further include a plurality of protrusions arranged to form a radial structure on the second bottom. The wash tray outlet may be arranged to be positioned at a center of the radial structure.

According to an embodiment of the present disclosure, a mop washing system includes a mop washing apparatus configured to rotate a mop. The mop washing system includes a mop washing apparatus configured to wash the mop by contacting the mop. The mop washing apparatus includes a main body, a water tank coupleable to and decouplable from the main body, and a wash tray configured to receive the mop and allow water from the water tank to flow in. The wash tray includes a first bottom including a guide wall configured to guide a flow of the inflowing water, the guide wall having an opening. The wash tray includes a second bottom arranged at a lower level than the first bottom to receive the water discharged through the opening and including a wash tray outlet configured to discharge the water to an outside of the wash tray. The mop washing apparatus includes a drain tray configured to coupleable to and decouplable from the wash tray and receive at least a portion of the wash tray while the drain tray is coupled to the wash tray so as to receive the water discharged from the wash tray outlet and including a drain tray outlet configured to discharge the received water. The mop washing apparatus includes a receiving groove arranged in the main body to be coupleable to and decouplable from the drain tray and configured to receive at least a portion of the drain tray to be detachable so as to receive the water discharged from the drain tray outlet and including a receiving groove outlet configured to discharge the received water.

The wash tray outlet may include a first wash tray outlet and a second wash tray outlet. The guide wall may be arranged on an edge of the first floor such that the water flowing into the first bottom may flow dividedly to the first wash tray outlet side and the second wash tray outlet side.

The drain tray outlet may be arranged such that the wash tray is inserted into the drain tray and covered by the wash tray.

The receiving groove outlet may include a strainer.

The main body may further include a lever arranged to be coupled to a portion of the wash tray and a portion of the drain tray and configured to seat the wash tray and the drain tray within the receiving groove.

The lever may be arranged to be rotatable within the main body and to allow the wash tray and the drain tray to be separated from the receiving groove. The plurality of protrusions may be arranged in a radial structure, and the wash tray may include a plurality of washing protrusions each arranged in a longitudinal direction of the protrusions.

The wash tray may further include a plurality of protrusions formed on the second bottom. The wash tray outlet may be arranged to be positioned at the center of the radial structure.

### Advantageous Effects

According to an embodiment, the wash tray outlet, the drain tray outlet, and the receiving groove outlet each may include the strainer to allow for the mop washing apparatus to be more easily maintained and kept cleaned.

According to an embodiment, the wash tray, the drain tray, and the receiving groove may be arranged to be separated from each other to facilitate maintenance and repairs of the mop washing apparatus.

According to an embodiment, the rotating mop may be brought into contact with the mop washing apparatus to automatically clean and spin-dry the mop.

According to an embodiment, a plurality of protrusions formed around the wash tray outlet may allow the time of flow of water to the wash tray outlet to be controlled, thereby saving water.

The effects to be obtained from the present disclosure are not limited to those mentioned above, and other effects not mentioned will be apparent to a person skilled in the art to which the present disclosure belongs from the following description.

### DESCRIPTION OF DRAWINGS

FIG. 1 is a view illustrating a mop washing system according to an embodiment.

FIG. 2 is a view of a mop washing apparatus according to an embodiment.

FIG. 3 is an exploded perspective view of the mop washing apparatus according to an embodiment.

FIG. 4 is an enlarged view of a wash tray shown in FIG. 3 according to an embodiment.

FIG. 5 is an enlarged view of a drain tray shown in FIG. 3 according to an embodiment.

FIG. 6 is a side cross-sectional view of the mop washing apparatus according to an embodiment.

FIG. 7 is a view illustrating a lever shown in FIG. 6 being rotating according to an embodiment.

FIG. 8 is a view illustrating a supply pipe and a drain pipe of the mop washing apparatus according to an embodiment.

FIG. 9 is a view illustrating a formation of a strainer at each of a wash tray outlet, a drain tray outlet, and a receiving groove outlet, according to an embodiment.

FIG. 10 is a view illustrating a mop washing system according to an embodiment.

### MODES OF THE INVENTION

Embodiments described in the disclosure and configurations shown in the drawings are merely examples of the embodiments of the disclosure and may be modified in various different ways at the time of filing of the present application to replace the embodiments and drawings of the disclosure.

In addition, the same reference numerals or signs shown in the drawings of the disclosure indicate elements or components performing substantially the same function.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, figures, steps, operations, elements, components, or combinations thereof, but do not preclude the presence or addition of one or more of the features, figures, steps, operations, elements, components, or combinations thereof.

It will be understood that, although the terms “first”, “second”, “primary”, “secondary”, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

The terms “front”, “rear”, “left”, “right”, “up (or upper)”, “down (or lower)”, and the like used in the following description are defined with reference to the drawings, but the shape and position of each element are not limited by the above terms.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

In referring to the direction of rotation, the clockwise direction may be represented as a first direction and the counterclockwise direction, which is the opposite of the first direction, as a second direction. Such representations may be used in describing specific details for practicing the disclosure, but the direction of rotation of the elements of the disclosure is not limited by these terms.

Hereinafter, various embodiments according to the disclosure will be described in detail with reference to the accompanying drawings.

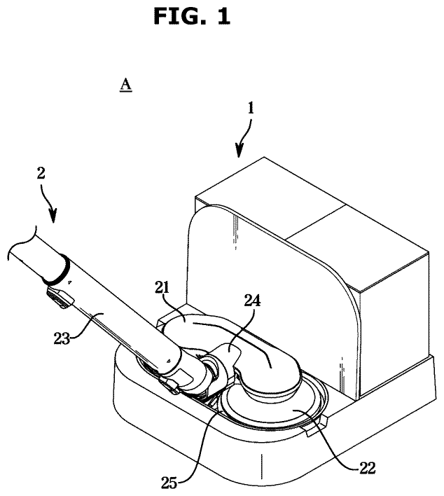

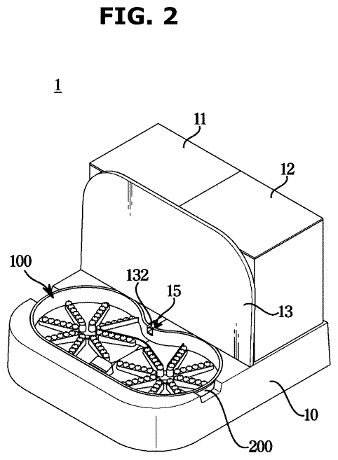

FIG. 1 is a view illustrating a mop washing system according to an embodiment. FIG. 2 is a view illustrating a mop washing apparatus according to an embodiment.

Referring to FIGS. 1 and 2, a mop washing system A may be defined as including a mop cleaner 2 and a mop washing apparatus 1 for washing a mop 25 of the mop cleaner 2. Although the mop cleaner 2 is shown in the drawings as a long-handle type mop cleaner, but the type of the mop cleaner 2 is not limited thereto.

The mop cleaner 2 may include a cleaner body 21, a mop mounting portion 22 that supports the mop 25 rotatably installed on a lower portion of the cleaner body 21, a handle (not shown) arranged on an upper portion of the cleaner body 21 for a user to grasp and drive the mop cleaner 2, and a connecting portion 24 that connects the cleaner body 21 and the handle.

The mop cleaner 2 may include an extension tube 23 configured to connect the connecting portion 24 and the handle. The extension tube 23 may be formed as a pipe having a predetermined stiffness or as a flexible hose.

The cleaner body 21 may be provided with a drive portion (not shown) for rotatably driving the mop 25 installed therein. A pair of mop mounting portions 22 may be rotatably installed on the bottom of the cleaner body 21. The mops 25 may each be detachably mounted on the lower portion of the mop mounting portions 22.

The connecting portion 24 may be rotatably connected to the cleaner body 21. The connecting portion 24 may be angle-adjustably connected to the cleaner body 21. The connecting portion 24 may further include at least one connecting tube.

Although not shown in the drawings, a handle of the mop cleaner 2 may be connected to the cleaner body 21 via the connecting portion 24. The handle may be provided with a button or the like configured to drive the cleaner body 21. In response to driving of the cleaner body 21, the mop 25 mounted on the mop cleaner 2 may be rotated. In other words, the mop 25 may be rotatably mounted on the cleaner body 21. The mop 25 is a wet mop used for wiping, and may be formed in a circular shape so as to be rotatable.

The mop 25 is configured to wipe the floor while rotating. The mop 25 may be formed of a general fabric material. The mop 25 may be detachably coupled to the mop mounting portion 22 of the cleaner body 21. The mop 25 may be detachably coupled to the mop mounting portion 22 by means of Velcro.

The mop 25 may be formed in a disc shape. The mop 25 may have mop hairs formed on both sides to allow for reversible use. The mop 25 may be detachably coupled to the mop mounting portion 22 with Velcro formed to allow the mop hairs to be removably attached.

The mop 25 mounted on the mop cleaner 2 may be washed by means of the mop washing apparatus 1. The mop washing apparatus 1 may include a main body 10 forming an exterior thereof.

The mop washing apparatus 1 may include a water tank 12 for providing washing water (hereinafter referred to as water) for washing the mop 25. The water for washing the mop 25 may be accommodated in the water tank 12. While the water tank 12 is shown in the drawings as having an approximately cuboid shape, but the shape of the water tank 12 is not limited thereto.

The mop washing apparatus 1 may include a drain tank 11 for receiving contaminated water after the mop 25 has been washed. The contaminated water at the end of washing the mop 25 may be received and stored in the drain tank 11. While the drain tank 11 is shown in the drawings as having an approximately cuboid shape, but the shape of the drain tank 11 is not limited thereto.

The water tank 12 and the drain tank 11 may be arranged on a rear side of the mop washing apparatus 1. The water tank 12 and the drain tank 11 may be arranged side by side.

The mop washing apparatus 1 may include a wash tray 100 on which the mop 25 is washed.

The mop washing apparatus 1 may be configured such that the mop 25 of the mop cleaner 2 is received in the wash tray 100 for washing the mop 25. Then, in response to the driving of the mop cleaner 2, the mop 25 may rotate, such that the mop 25 may be washed by interaction with the wash tray 100. A detailed configuration of the wash tray 100 interacting with the mop 25 will be described later.

The main body 10 may include a water supply pipe 15. The wash tray 100 may include an inlet 132. The inlet 132 and the water tank 12 may be connected through the water supply pipe 15. Water may be supplied to the wash tray 100 through the water supply pipe 15.

The main body 10 may include a drain pipe 17. The drain pipe 17 may flow contaminated water into the drain tank 11 after washing is completed. A detailed description of the water supply pipe 15 and the drain pipe 17 will be described later.

In a case where the mop cleaner 2 is washed in the wash tray 100, the water may splash around and contaminate the mop washing apparatus 1. To prevent such a situation, the water tank 12 and the drain tank 11 may be configured to be separated from the wash tray 100 by a partition wall 13 arranged in the main body 10.

The partition wall 13 may be positioned between the water tank 12 and the drain tank 11, and the wash tray 100. The partition wall 13 may be arranged to be higher than the water tank 12 and the drain tank 11. The partition wall 13 may be detachably coupled to the main body 10, and thus the water splashed on the partition wall 13 may be easily removed and managed.

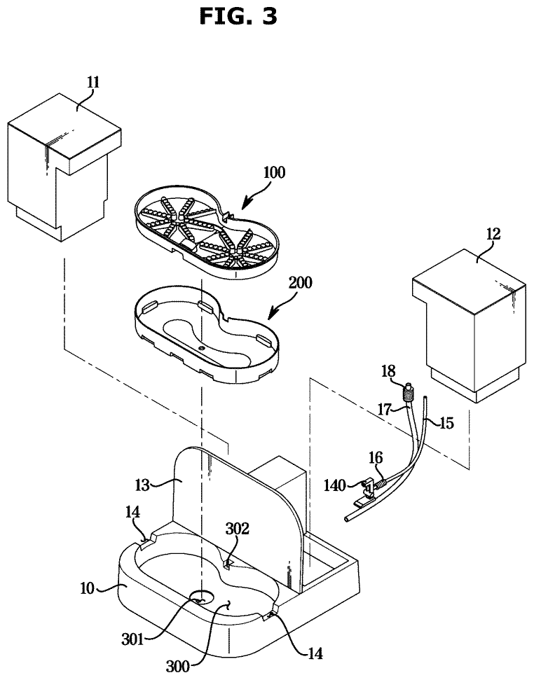

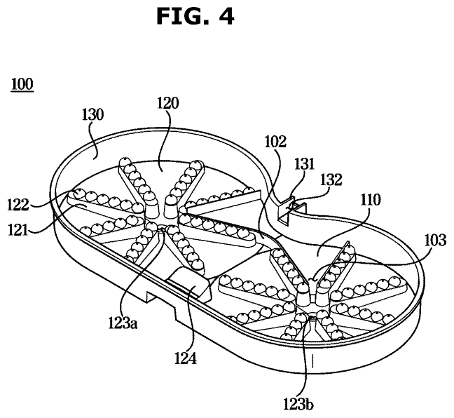

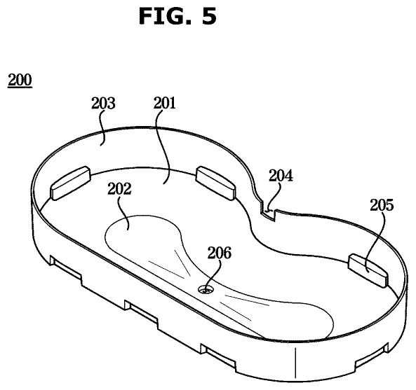

FIG. 3 is an exploded perspective view of the mop washing apparatus according to an embodiment. FIG. 4 is an enlarged view of the wash tray shown in FIG. 3. FIG. 5 is an enlarged view of the drain tray shown in FIG. 3.

Referring to FIGS. 3 to 5, the water tank 12 and the drain tank 11 may be arranged to be separable from the main body 10. The water tank 12 may be separable from the main body 10 to facilitate filling the water tank 12 with water. The drain tank 11 may be separable from the main body 10 to facilitate removal of contaminated water contained in the drain tank 11.

The wash tray 100 may include a first bottom 110. The first bottom 110 may be configured to allow the water to flow in and include a guide wall 102 configured to guide a flow of the inflowing water.

The guide wall 102 arranged on the first bottom 110 may include an opening 103. The wash tray 100 may include a second bottom 120 arranged at a lower level than the first bottom 110 to receive water discharged through the opening 103.

The water supplied to the wash tray 100 via the inlet 132 may flow along the first bottom 110. The water may then encounter the guide wall 102 arranged on the first bottom 110 and flow along the guide wall 102, and may fall from the first bottom 110 to the second bottom 120 through the opening 103 arranged on the guide wall 102.

The second bottom 120 may include a plurality of protrusions 121. While the protrusions 121 are shown in the drawings as having an elongated, approximately hexahedral shape, but the shape thereof is not limited thereto. The plurality of protrusions 121 may be arranged to form a radial structure.

A plurality of protrusions 122 may be arranged on an upper surface of the protrusions 121. The protrusions 122 may have an approximately spherical shape, but are not limited thereto.

The plurality of protrusions 122 may be arranged parallel to a longitudinal direction of the protrusions 121. The mop of the mop cleaner 2 may be arranged to rub against the plurality of protrusions 122. The mop 25 may be washed by such friction.

The second bottom 120 may include a wash tray outlet 123 configured to discharge water to an outside of the wash tray 100. The wash tray outlet 123 may be provided in a plurality. In other words, the wash tray outlet 123 may include a first wash tray outlet 123a and a second wash tray outlet 123b.

In the case where the wash tray outlet 123 is provided in a plurality, the guide wall 102 may be arranged on an edge of the first bottom 110 such that the water flowing into the first bottom 110 may flow dividedly to the first wash tray outlet 123a side and the second wash tray outlet 123b side. By allowing the guide wall 102 to divide the water flow, the second bottom 120 may have a uniform water flow throughout.

The wash tray outlet 123 may be arranged to be positioned at the center of the radial structure formed by the plurality of protrusions 121. Accordingly, in the case where the number of wash tray outlets 123 is a plurality, the radial structure formed by the plurality of protrusions 121 may also be arranged to correspond to the number of wash tray outlets 123.

The radial structure formed by the plurality of protrusions 121 may be arranged in such a way that a channel along which the water can flow narrows closer to the center of the radial structure. Accordingly, the water may not flow quickly toward the center of the radial structure. In other words, since the wash tray outlet 123 is positioned at the center of the radial structure, the water received in the wash tray 100 may not be quickly discharged to the outside of the wash tray 100. Therefore, the water may be retained in the wash tray 100 for a longer period of time, and such a structure of the wash tray 100 may allow the mop 25 to be washed more effectively with the same amount of water due to the increased time that the mop 25 is in contact with the water. As a result, the water may be used more economically.

The second bottom 120 may be provided with a cleaner support member 124. The mop cleaner 2 may be seated on the cleaner support member 124.

A height of the cleaner support member 124 may be suitably arranged such that the cleaner body 21 of the mop cleaner 2 does not come into contact with the water. In other words, since the cleaner body 21 does not come into contact with the water to prevent failure of the cleaner body 21, the mop 25 may be received in the wash tray 100 and washed in combination with the mop cleaner 2.

The wash tray 100 may include a wash tray side wall 130 configured to surround an outer circumference thereof. The amount of water received in the wash tray 100 may be determined by the height of the wash tray side wall 130.

The wash tray side wall 130 may be formed with an inflow channel 131 to position the inlet 132 into which water is introduced. The inflow channel 131 may be arranged to protrude from the wash tray side wall 130.

The mop washing apparatus 1 may include a drain tray 200 configured to receive at least a portion of the wash tray 100. The drain tray 200 may be detachably coupled to the wash tray 100.

The water used for washing the mop 25 in the wash tray 100 may be discharged through the wash tray outlet 123 and received in the drain tray 200.

The drain tray 200 may include a first drain surface 201 that forms a bottom of the drain tray 200. The drain tray 200 may include a second drain surface 202 that forms a bottom of the drain tray 200. The second drain surface 202 may be arranged to be disposed on a central side of the first drain surface 201.

The second drain surface 202 may be provided with a drain tray outlet 206. Water received in the drain tray 200 may flow over the first drain surface 201 and the second drain surface 202, and thus may be discharged to an outside of the drain tray 200 through the drain tray outlet 206. To this end, the second drain surface 202 may be formed to be inclined downwardly from the first drain surface 201 toward the drain tray outlet 206.

The second drain surface 202 may be inclined downwardly toward the drain tray outlet 206, so that water may flow to be easily discharged to the drain tray outlet 206.

The drain tray outlet 206 may be disposed at the center of the second drain surface 202. The drain tray outlet 206 may be arranged such that the wash tray 100 is coupled to the drain tray 200 and covered by the wash tray 100. In other words, in response to the coupling of the wash tray 100 to the drain tray 200, the drain tray outlet 206 may be arranged such that the drain tray outlet 206 may not be observed through the wash tray outlet 123. Accordingly, the contaminated water discharged through the wash tray outlet 123 may not flow directly to the drain tray outlet 206, but may be arranged to flow first over the first drain surface 201 and the second drain surface 202.

As the contaminated water flows over the first drain surface 201 and the second drain surface 202, a substantial portion of foreign substances may be left on the first drain surface 201 and the second drain surface 202. Accordingly, a portion of the contaminants in the water discharged through the drain tray outlet 206 may be removed. As a result, the contamination of a receiving groove 300 (to be described later) that receives the water discharged from the drain tray outlet 206 may be reduced, and subsequently the contamination level of the main body 10 in which the receiving groove 300 is formed may be managed at a relatively low level.

The drain tray 200 may include a drain tray side wall 203. The drain tray side wall 203 may be shaped to protrude from a perimeter of the first drain surface 201. The amount of water that may be accommodated in the drain tray 200 may be adjustable depending on the height of the drain tray 200.

The drain tray 200 may be formed with a recessed portion 204. In particular, the recessed portion 204 may be formed in the side wall of the drain tray 200. In response to the coupling of the wash tray 100 to the drain tray 200, the inflow channel 131 of the wash tray 100 may be inserted into the recessed portion 204 of the drain tray 200.

The drain tray 200 may include a support 205. The support 205 may be arranged to protrude from the first drain surface 201. The support 205 may be arranged to abut the drain tray side wall 203. The height at which the support 205 protrudes from the first drain surface 201 may be lower than the height at which the drain tray side wall 203 protrudes from the perimeter of the first drain surface 201. The support 205 may be provided in a plurality.

In response to the coupling of the wash tray 100 to the drain tray 200, the wash tray 100 may be supported by being seated on the supports 205. As a result, the second bottom 120 of the wash tray 100 and the first drain surface 201 of the drain tray 200 may be arranged not to contact.

The main body 10 may include the receiving groove 300 in which at least a portion of the drain tray 200 may be detachably received. The receiving groove 300 may detachably receive at least a portion of the wash tray 100.

The receiving groove 300 may receive the water discharged from the drain tray 200. The receiving groove 300 may include a receiving groove outlet 301 that discharges the water to an outside of the receiving groove 300.

The main body 10 may include a release groove 14 provided on the receiving groove 300 side to separate the wash tray 100 and the drain tray 200 from the receiving groove 300. In other words, the release groove 14 may be a groove provided in the main body 10 to allow a user to grip the wash tray 100 and the drain tray 200 in a state in which they are received in the receiving groove 300 and easily remove them from the receiving groove 300.

Although the release grooves 14 are shown in the drawings as having a recessed shape on both sides of the receiving groove 300, they may be provided in any shape that facilitates the user's gripping of the wash tray 100 and the drain tray 200.

The main body 10 may include an inflow channel seat portion 302. The inflow channel seat portion 302 may be arranged on the receiving groove 300 side. Based on the wash tray 100 and the drain tray 200 being received in the receiving groove 300, the protruding inflow channel 131 of the wash tray 100 may be inserted into the inflow channel seat portion 302 of the main body 10.

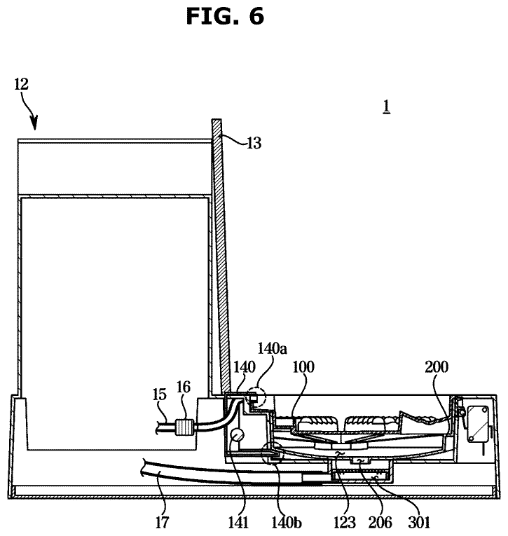

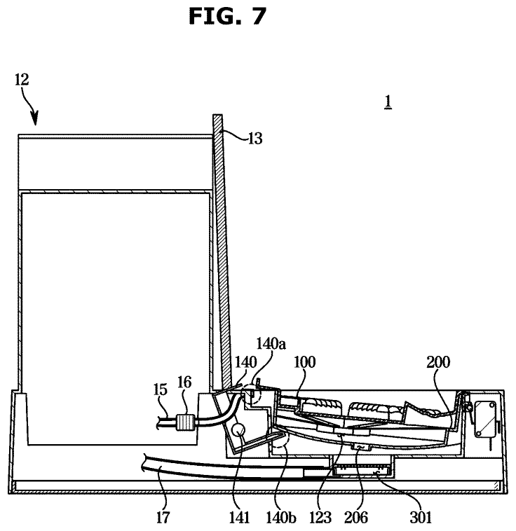

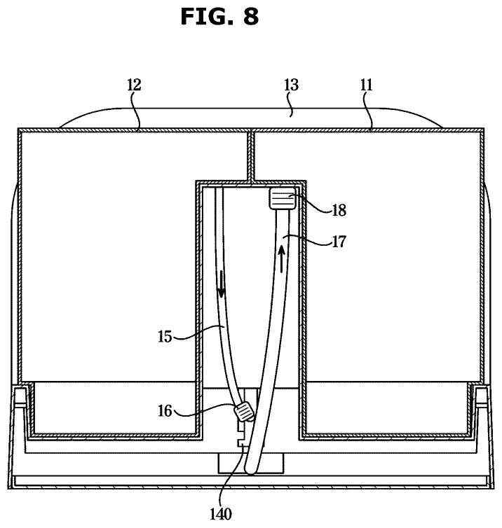

FIG. 6 is a side cross-sectional view of the mop washing apparatus according to an embodiment. FIG. 7 is a view showing a lever shown in FIG. 6 being rotating. FIG. 8 is a view showing the supply pipe and the drain pipe of the mop washing apparatus according to an embodiment.

Referring to FIGS. 6 to 8, the main body 10 may include a lever 140. The lever 140 may be coupled to a portion of the wash tray 100. The lever 140 may be coupled to a portion of the drain tray 200. In particular, the lever 140 may be curved or bent to accommodate a portion of the wash tray 100 and the drain tray 200.

Based on the wash tray 100 and the drain tray 200 being received in the receiving groove 300, one end 140a of the lever may be arranged to be positioned on the wash tray 100 side. The other end 140b of the lever may be arranged to be positioned on the lower surface side of the receiving groove 300.

Based on the wash tray 100 and the drain tray 200 being received in the receiving groove 300, the wash tray 100 and the drain tray 200 may be received in such a way that one end 140a of the lever is in contact with the inflow channel 131 of the wash tray 100 and the other end 140b of the lever is in contact with the lower surface of the drain tray 200.

The other end of the water supply pipe 15 may be arranged to extend toward the inlet 132 in contact with one end 140a of the lever.

The lever 140 may include a rotation shaft 141. The lever 140 may be shaped to receive a portion of the rotation shaft 141.

The lever 140 may be arranged to be rotatable about the rotation shaft 141 within the main body 10. The user may easily separate the wash tray 100 and the drain tray 200 from the receiving groove 300 by rotating the lever 140.

More particularly, the user may rotate the lever 140 about the rotation shaft 141 by pushing one end 140a of the lever. In response to rotation of the lever 140, one end 140a of the lever may be separated from the inflow channel 131 of the wash tray 100. In addition, as the lever 140 rotates, the other end 140b of the lever may be pushed in a direction to separate the lower surface of the drain tray 200 from the receiving groove 300.

In this process, the wash tray 100 and the drain tray 200 may be easily separated from the receiving groove 300 by the rotation of the lever 140.

The main body 10 may include the water supply pipe 15 communicating the water tank 12 and the inlet 132. One end of the water supply pipe 15 may communicate with the water tank 12. The other end of the water supply pipe 15 may communicate with the inlet 132. The water supply pipe 15 may be provided with a water supply pump 16. In response to operation of the water supply pump 16, the water contained in the water tank 12 may be sprayed through the water supply pipe 15 to the inlet 132.

The main body 10 may include the drain pipe 17 communicating the receiving groove outlet 301 with the drain tank 11. One end of the drain pipe 17 may communicate with the receiving groove outlet 301. The other end of the drain pipe 17 may communicate with the drain tank 11. The drain pipe 17 may be provided with a drain pump 18. In response to operation of the drain pump 18 operates, the contaminated water on the receiving groove outlet 301 side may flow down the drain pipe 17 to the drain tank 11 for receiving.

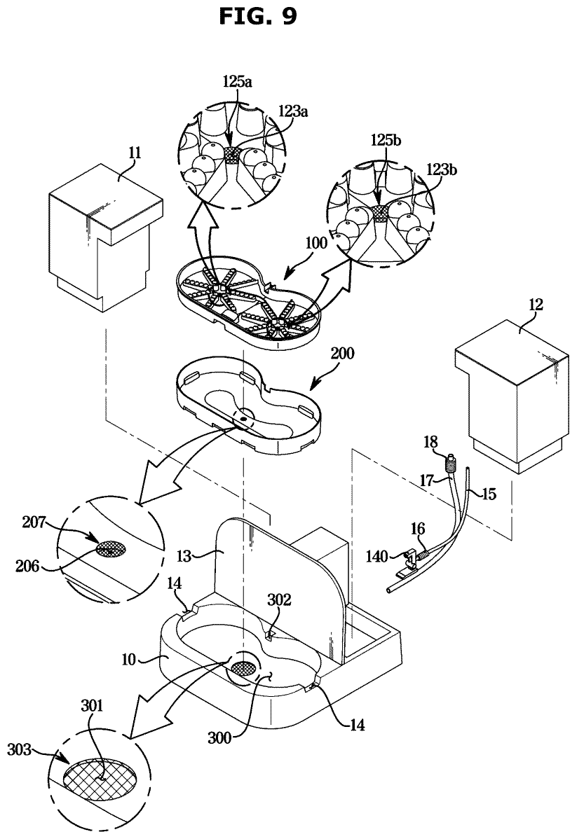

FIG. 9 is a view showing a formation of a strainer at each of the wash tray outlet, the drain tray outlet, and a receiving groove outlet, according to an embodiment.

Referring to FIG. 9, the wash tray outlet 123 may be provided with strainers 125a and 125b. After the mop 25 is washed, a large volume of foreign substances present in the water may not pass through the wash tray outlet 123 and may be trapped by the strainers 125a and 125b.

The drain tray outlet 206 may be provided with a strainer 207. When the water discharged from the wash tray outlet 123 is received and discharged to the drain tray outlet 206, foreign substances may be filtered out again by the strainer 207 provided at the drain tray outlet 206.

The receiving groove outlet 301 may be provided with a strainer 303. By filtering the water filtered out by the strainers 125a and 125b provided at the wash tray outlet 123 and the strainer 207 provided at the drain tray outlet 206 again by the strainer 303 provided at the receiving groove outlet 301, the phenomenon of the drain pipe 17 being blocked by foreign substances or the like may be prevented.

In addition, since a substantial amount of foreign substances in the contaminated water is removed from the wash tray 100 and the drain tray 200, the main body 10 may be relatively cleanly maintained and managed.

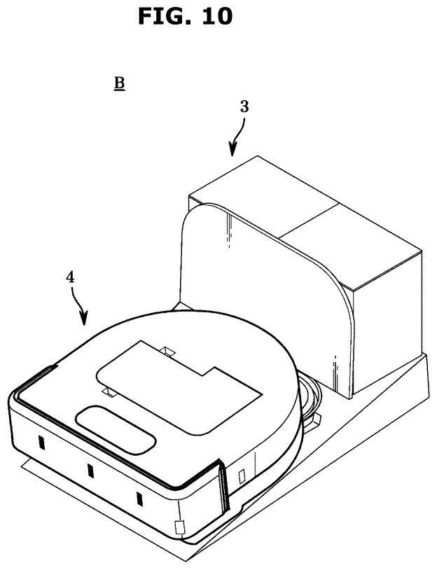

FIG. 10 is a view illustrating a mop washing system according to an embodiment.

Referring to FIG. 10, the mop washing system B may be defined as including a mop cleaner 4 and a mop washing apparatus 3 for washing the mop 25 of the mop cleaner 4. More particularly, the mop cleaner 4 may include the mop cleaner 4 adapted to a robot cleaner. In other words, the mop cleaner 4 may include not only a long-handle type mop cleaner but also a robotic cleaner type mop cleaner. Similarly, although the mop cleaner 4 is shown as in the drawing as being a robotic mop cleaner, the type of the mop cleaner is not limited thereto.

While the present disclosure has been particularly described with reference to exemplary embodiments, it should be understood by those of skilled in the art that various changes in form and details may be made without departing from the spirit and scope of the present disclosure.

1. A mop washing apparatus comprising:
a main body;
a water tank coupleable to and decouplable from the main body;
a wash tray configured to receive a mop to be washed and receive water supplied from the water tank while the water tank is coupled to the main body, the wash tray including:
a first bottom including a guide wall configured to guide a flow of the water supplied from the water tank, the guide wall having an opening, and
a second bottom arranged at a lower level than the first bottom to receive the water guided through the opening of the guide wall of the first bottom, the second bottom including a wash tray outlet configured to discharge the water to an outside of the wash tray;
a drain tray configured to be coupleable to and decouplable from the wash tray and receive at least a portion of the wash tray while the drain tray is coupled to the wash tray; and
a receiving groove, arranged in the main body, to be coupleable to and decouplable from the drain tray and configured to receive at least a portion of the drain tray while the receiving groove is coupled to the drain tray.

2. The mop washing apparatus of claim 1, wherein
the wash tray outlet comprises a first wash tray outlet and a second wash tray outlet, and
the guide wall is arranged on an edge of the first bottom such that the water flowing into the first bottom flows dividedly to the first wash tray outlet and the second wash tray outlet.

3. The mop washing apparatus of claim 1, wherein the main body further comprises a release groove arranged in the receiving groove to allow the wash tray and the drain tray to be separated from the receiving groove.

4. The mop washing apparatus of claim 1, wherein
the drain tray is configured to receive the water discharged from the wash tray outlet, and
the drain tray comprises a drain tray outlet configured to discharge the received water to an outside of the drain tray.

5. The mop washing apparatus of claim 4, wherein the drain tray outlet is arranged such that the wash tray is coupled to the drain tray and covered by the wash tray.

6. The mop washing apparatus of claim 4, wherein
the receiving groove is configured to receive the water discharged from the drain tray, and
the receiving groove comprises a receiving groove outlet configured to discharge the water to an outside of the receiving groove.

7. The mop washing apparatus of claim 6, wherein the receiving groove outlet comprises a strainer.

8. The mop washing apparatus of claim 1, wherein
the wash tray further comprises an inlet in which the water flows, and
the main body further comprises a water supply pipe configured to communicate the water tank with the inlet.

9. The mop washing apparatus of claim 6, wherein the main body further comprises:
a drain tank coupleable to and decouplable from the main body, and
a drain pipe configured to communicate the receiving groove outlet with the drain tank.

10. The mop washing apparatus of claim 1, wherein the main body further comprises a lever arranged to be coupled to a portion of the wash tray and a portion of the drain tray and configured to seat the wash tray and the drain tray within the receiving groove.

11. The mop washing apparatus of claim 10, wherein the lever is arranged to be rotatable within the main body and to allow the wash tray and the drain tray to be separated from the receiving groove.

12. The mop washing apparatus of claim 4, wherein the wash tray outlet and the drain tray outlet each comprises a strainer.

13. The mop washing apparatus of claim 2, wherein
the wash tray further comprises a plurality of protrusions arranged to form a radial structure on the second bottom, and
the wash tray outlet is arranged to be positioned at a center of the radial structure.
